(19) United States
(12) Patent Application Publication
(10) Pub. No.: US 2004/0154041 A1
(43) Pub. Date: Aug. 5, 2004

(54) Optimized data streaming and uses thereof

(76) Inventor: Gary Xiao-Liang Zhang, Yorktown Heights, NY (US)

Correspondence Address: Albert Wai-Kit Chan, Law Offices of Albert Wai-Kit Chan, LLC, World Plaza, Suite 604, 141-07 20th Avenue, Whitestone, NY, 11357, US

(21) Appl. No.: 10/764,073

(22) Filed: Jan. 23, 2004

Related U.S. Application Data
(60) Provisional application No. 60/442,202, filed on Jan. 24, 2003.

(51) Int. Cl. H04N 7/18

(52) U.S. Cl. 725/74

(57) ABSTRACT

A variable-rate compressed multimedia data stream is typically characterized by relatively short intervals of relatively high local bitrate between relatively long intervals of relatively low bitrate. Typically, the perceived quality of the presentation at playback depends heavily on this data with locally high rate. However, it is this segment that is also most susceptible to stalls in bandwidth, and most limited by underflow constraints imposed by most current streaming techniques. This invention provides a novel simple solution to maximize use of all available bandwidth to pre-stream such data in an auxiliary channel while streaming the rest of the presentation along a main channel, called Tortoise and Hare Streaming. This method also realizes high robustness in the face of jittery bandwidths with minimal additional memory or computation resources at both the server and the client. Methods to decide which channel a given block of data should be allocated to for transmission are disclosed. Methods to determine a schedule for transmission in each channel based upon conditions such as network conditions, presentation quality are also disclosed. Finally, a complete architecture from authoring to playback for an embodiment of the system is provided.

This application claims priority of U.S. Serial No. 60/442,202, filed Jan. 24, 2003, the content of which is incorporated by reference here into this application.

### BACKGROUND OF THE INVENTION

Streaming is the continuous delivery of data from a server to a client. Typically, such data carries multimedia information. One session of such a multimedia delivery will be referred to as a presentation. The fundamental unit of a presentation is a frame. The rate at which data is streamed is called the bitrate. Multimedia information is typically compressed before being streamed. The compressed presentation, whether in storage or in transit via streaming, is called a bitstream. For a given compression scheme, an increase in the compressed bitrate usually results in an increase of the quality of the decompressed multimedia. However, the rate of improvement achieved depends on the nature of the presentation. Slowly-varying information, on one hand, quickly maxes out in quality. A constant white image, for instance, does not benefit from more than a few bits added to its compressed representation. Rapidly varying information, on the other hand, can benefit dramatically if more bits are used. On an average, a given part of a presentation will lie between these two extremes. Thus to maintain a certain quality of presentation, easy areas require fewer bits, difficult areas require more bits, and most of the presentation requires roughly a constant number of bits. If a presentation requires almost the same number of bits per frame, it is a constant-rate presentation. If a presentation requires significantly varying bits per frame, it is a variable-rate presentation. The exact implication of “almost same” and “significantly varying” depends on the application, but usually is measured relative to the bitrate of the presentation and the available bandwidth.

Note that this definition of streaming does not limit the types of servers used to what are usually called “streaming servers”. Simple HTTP delivery that progresses over time, for example, is also a form of streaming that can be accommodated within an embodiment. Also, while most of this disclosure will describe operations under the conditions of push-streaming (i.e. where the server schedules and sends data for the client to accept), pull-streaming (i.e. where the client schedules transfers and the server sends data in response to client requests) is possible in an embodiment and this disclosure should make its implementation obvious to a person skilled in the art. Regardless of the specific method of implementation, streaming is usually done over a network. The maximum number of bits the network can deliver from the server to the client is called the bandwidth. Connections usually have a specified nominal bandwidth, but actual bandwidth at a given instance of time may significantly fluctuate from the nominal depending on network conditions. The data received via streaming is stored in a buffer at the client. Streaming is typically done under fixed buffer constraints. At the client end, both overflow and underflow are conditions to guard against—overflow being more data available than storage at a given point of time and underflow being the non-arrival of required data at a given point of time. Typically, such conditions are avoided by limiting the amount of fluctuation in bitrate, i.e. maintaining a constant bitrate when averaged over some window of time. However, these restrictions often lead to degradation of achieved quality, since prolonged areas requiring a low bitrate are forced to use more bits, while difficult areas requiring more bits cannot be accommodated beyond a certain level. With increasing storage capability available on all devices, buffer overflow is no longer a critical constraint.

However, underflow is still a problem, and available bandwidth still limits the number of bits that can be assigned to a small part of the bitstream without causing underflow at the client end. The device(s) or software that take the bitstream and process it to render the presentation are collectively called the player. The player and the client may be the same, or related, or different. Typically a compressed media stream consists of key frames and dependent frames. Key frames are coded independently of any other frame, and are self-sufficient for decoding. Dependent frames are coded on the basis of previous and/or future key frames, and require these frames to be decoded before they themselves can be decoded.

Consider a stock ticker stream. Its key frames typically carry at least full symbol and price information, along with index numbers by which future offsets are tied to a specific stock trace. Dependent frames typically carry at least index numbers and offsets of the current frame's price from the last frame's price.

Consider an MPEG-4 video file. It consists of: Intra-coded pictures, or I-frames, that are independently compressed representations of a single frame, Predicted pictures, or P-frames, that are predicted based on a previous I-frame or P-frame, and Bi-directional pictures, or B frames, that are predicted based on previous or future I frames or P frames.

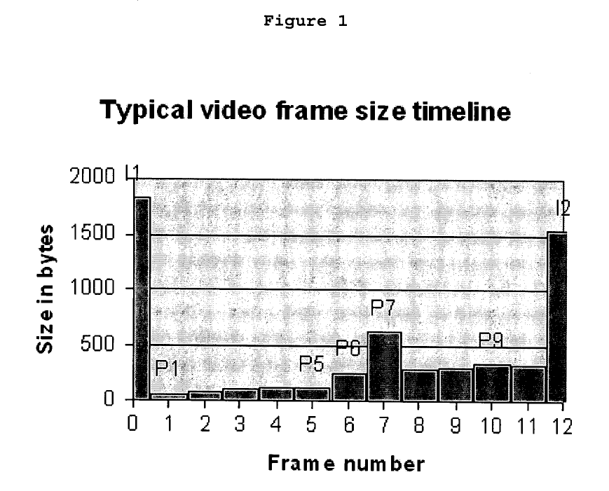

An I frame is a key frame for video sequences. P and B frames are dependent frames. A typical bitstream of such video consists of many P or B frames with sparsely spaced I-frames. (In general, any compressed representation of a media stream consists of a several dependent frames with sparsely spaced key frames) A key can be several to a few hundred times larger than a dependent frame, and its quality is a significant determining factor of the resultant quality achieved by the following dependent frames for a given bitrate. Thus, as shown in FIG. 1, the key frame (an I frame for video) represents a significant bottleneck of high data rate as opposed to the generally low data rate required by the intermediate dependent frames. I1 and I2 are I frames, the rest are P frames. Note that P7 is a P-frame with a locally high size. A naive streaming algorithm that sent the stream at a currently local bitrate would cause a large stall when sending an I-frame (since the local bitrate there is much higher than the average), and at all other times would significantly under-use the available bandwidth. Typical streaming solutions push the stream continuously as close to M bps as possible. This requires enough memory at the client to store up to several intermediate frames and an I-frame, since an I-frame must be pushed by the time a B-frame that depends on it is due. Otherwise, underflow, i.e. a stall will result. There are some disadvantages to this method:

When several I-frames come in at close succession to each other, large stalls will almost certainly result as the average bandwidth locally rises to much larger than M bps, and is sustained over a period of time longer than the duration between two I-frames. This causes degraded viewing experience at a time when the video is likely to be sensitive to any degradation, given that several I frames have been coded in close vicinity, indicating rapid change in the video.

The streaming cannot be immediately adapted to sudden drops in bandwidth, which can occur quite frequently, especially with dial-up or wireless connections. Specifically, if a bandwidth drop occurs exactly when an I-frame is being sent across, a serious stall is likely to result, since I-frames typically arrive almost just in time for display.

In general, under this traditional model, parts of the bitstream containing dependent frame areas are streamed at higher than local bitrates, to make way for the I-frame when it arrives. However, since buffer space at the client is usually limited, there is a limit to how far ahead such pre-fetching can stretch. Specifically, even if the local bitrate at ten minutes into a video is 0.8 times M, and the local bitrate at fifteen minutes is 1.2 times M (which will cause underflow conditions), it is not always possible to utilize the extra 0.2 times M bandwidth around the tenth minute by sending more frames in the same time, since the buffer may not be capable of storing the intermediate 3-4 minutes of video. The problem occurs because all frames must be streamed in sequence.

Recently, solutions such as fine-grained scalability have been proposed to increase robustness to local variations in bandwidth by sending limited resolution video at lower bandwidths, and progressively higher resolution or quality are more bandwidth becomes available. While this guarantees the highest possible local quality, it suffers from increased encoder, decoder and server complexity, and still does not allow for guaranteed high-quality I-frames without risks of underflow.

### SUMMARY OF THE INVENTION

The invention described herein provides a novel dual-stream method of streaming variable-rate data. The dual-stream scheme can be easily extended to multiple streams. The invention further provides a scheme to allocate available bandwidth among channels. The invention also provides a scheme to send parts of a stream -with locally large bandwidth over one or more auxiliary channels while the rest of the data in that stream is sent over one or more base channels. While the system will be largely described in terms of an embodiment serving simple profile MPEG-4 video, a person skilled in the art will recognize that the system is applicable to all types of multimedia where quality-sensitive material requires localized high bitrates as compared to the average bitrate requirement of the bitstream.

The system is applicable in all cases where data and data statistics are available sufficiently beforehand, and in live recording and broadcast scenarios when sufficient latency (permitting the generation of a subsequent high-bitrate segment before transmission of a current low-bitrate segment) is tolerable.

### DETAILED DESCRIPTION OF THE FIGURES

FIG. 1: Typical Video Size Timeline. The figure depicts a typical sequence of frame sizes for MPEG-4 video consisting of I and P frames. Note that an I frame can be, typically, 5 to 100 times larger than the average dependent frame.

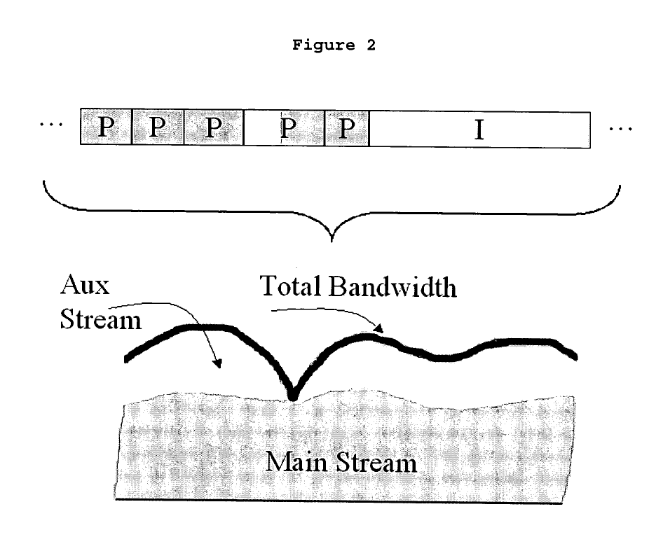

FIG. 2: An instance of Tortoise and Hare Streaming. The figure depicts the sizes of frames whose streaming is illustrated. It further depicts the manner in which data is divided for streaming between the main and auxiliary channels, in an exemplary embodiment. It further depicts the fact that the sum bandwidth of all channels at a given time is the total network bandwidth in use by the streaming at that time. Finally, it depicts the adjustment of streamed data under stalled network conditions, in an exemplary embodiment.

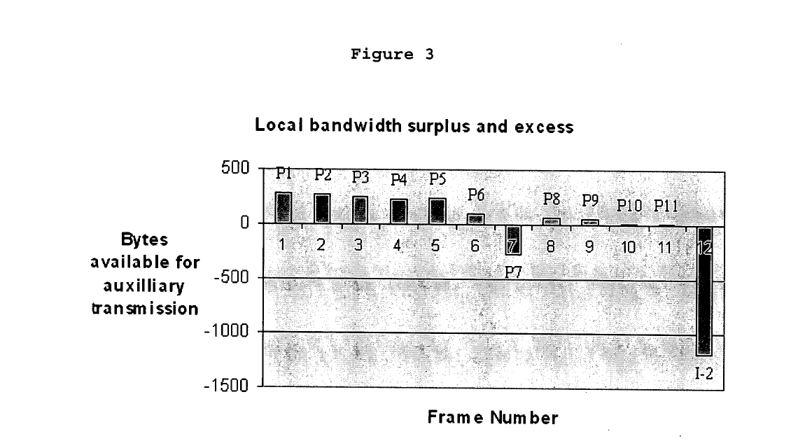

FIG. 3: Local Bandwidth Surplus and Excess. For the data depicted in FIG. 1, and an assumed network bandwidth of 350 bytes/frame duration, FIG. 3 depicts the excess bandwidth available on a frame-by-frame basis. Where a frame size exceeds the assumed network bandwidth, the excess is negative-indicating a deficit.

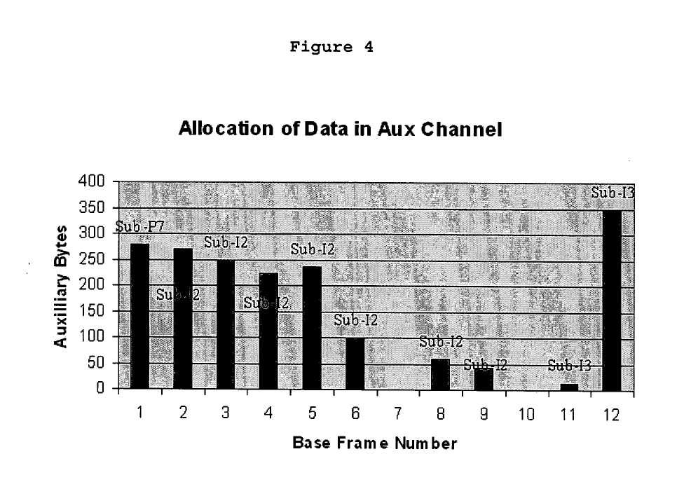

FIG. 4: Allocation of Data in Auxiliary Channel. Depicts the scheme used by Turtle and Hare Streaming to allocate data into an Auxiliary Channel for the data shown in FIG. 3, in an exemplary embodiment.

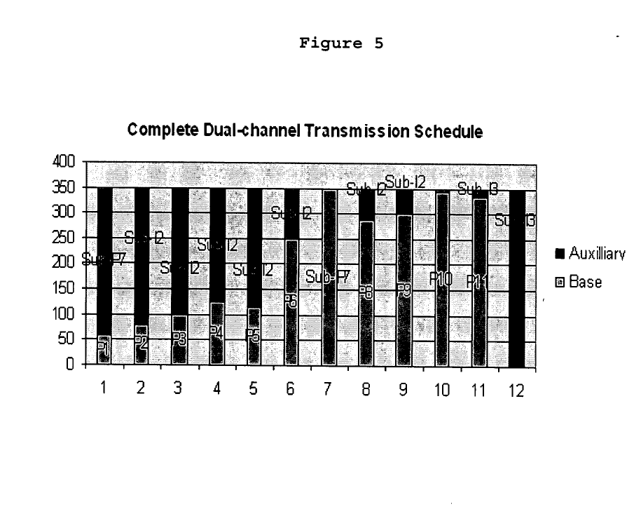

FIG. 5: Complete Dual-Channel Transmission Schedule. Depicts the transmission schedule of data among channels on a frame-by-frame basis for the frame sequence shown in FIG. 1, using the conditions depicted in FIG. 3, and the allocation depicted in FIG. 4.

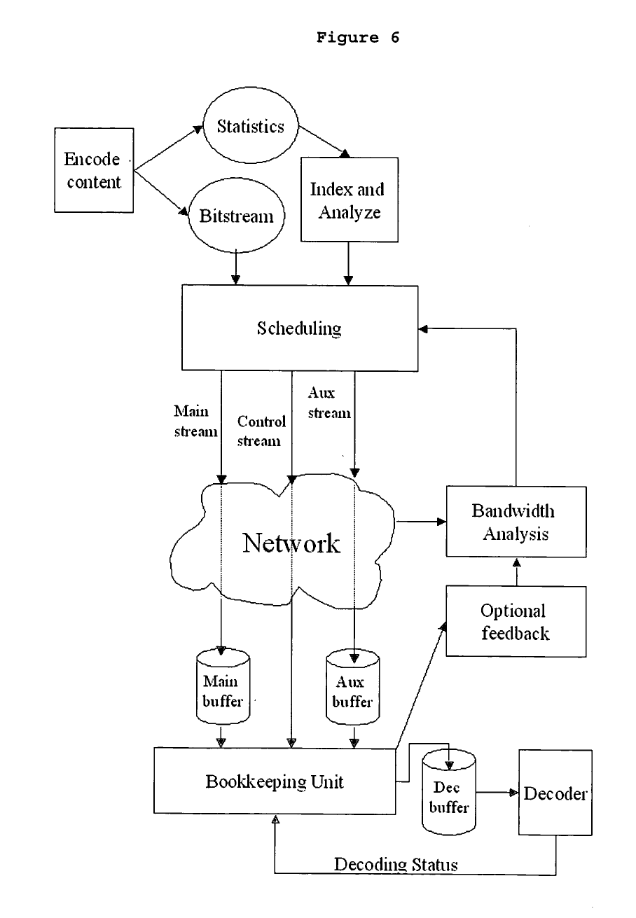

FIG. 6: This provides an end-to-end flow diagram of an embodiment of the system described here, using a push-streaming scenario. Authoring, scheduling, playback and feedback stages of the process are depicted.

### DETAILED DESCRIPTION OF THE INVENTION

The invention described here is a simple yet elegant solution to overcome the unpredictability and locally spiked bitrates while transmitting variable-rate streams, while maintaining encoder, decoder and server simplicity. The proposed system exploits the difference between the nominal rate of the dependent frames and the available bandwidth to pre-download coming large frames using a separate (parallel) streaming mechanism. The larger frames (either key or oversized dependents) are thus ready and available at the time they are required without locally choking bandwidth and risking buffer underflow. The main streaming mechanism is called the base channel, and the incremental download mechanism(s) the auxiliary channel(s). Such streaming is called Tortoise and Hare streaming. Correspondingly, data sent over the base channel comprises the base stream, and data sent over the auxiliary channel comprises the auxiliary stream. FIG. 2 provides an exemplary snapshot of such streaming.

Once again, it should be stressed that the “streams” may not be data streams in the conventional streaming sense—they could be continuous http downloads or any other similar mechanism. Further, it is not necessary that all streams be streamed using the same protocol—it is conceivable that the main stream would be sent over a UDP (an error-prone protocol) stream while the auxiliary stream is sent over HTTP (to ensure correct delivery of a quality-sensitive I-frame, for instance). For other applications such as stock ticker transmissions, both main and auxiliary streams would certainly be sent using error-free protocols.

The idea is to stream dependent frames at their nominally required rate, so that they arrive 2-3 frames prior to required use. This nominal rate is typically 0.9 times M, but could fluctuate significantly either way. Accordingly, the key frame (or surplus dependent frame) is transmitted normally at around 0.1 times M—higher when the dependent frames require lower bandwidth and lower when they require more. Naturally, when the local bitrate for a dependent frame is exactly M, no data can be concurrently sent over the auxiliary channel. Where it is possible to profile the bitrate of the video over a large window in time, and adequate buffer space is available at the client, it is possible to schedule subsequent I-frames to be optimally delivered in parallel with previous dependent frames so that all available bandwidth is completely used. As shown in FIG. 2, if a stall in bandwidth occurs, then smart decisions to drop dependent frames and instead give priority to a subsequent key frame can be made. Thus, the possibility of serious underflow in the face of stalled bandwidth is reduced since a major part of the key frame is sent out over a long window of time when adjustments for changes in bandwidth can be more efficiently compensated for.

The memory requirements for this scheme are not significantly larger than those of traditional streaming. However, with the scheme, disclosed herein much larger key frames can generally be sent than is possible with traditional streaming, without the accompanying risk of underflow. Thus, high quality at a scene change is more likely. Further, in the case of video for example, if I-frames are sufficiently crisp, subsequent P-frames are likely to be smaller. This in turn allows for larger subsequent I-frames, since the bandwidth surplus afforded by smaller P frames can be used to send the larger upcoming I-frame. Thus, the scheme paves the way for itself, in a manner of speaking. Better quality and lower risk of underflow are achieved simply by profiling the video to a sufficient look-ahead distance and pre-sending as much data from bottleneck areas of the bitstream as possible. FIG. 3 illustrates the excess or paucity of local bandwidth relative to the frame sizes shown in FIG. 1. FIG. 4 then illustrates the schedule to exploit this locally available bandwidth for auxiliary channel transmissions for the same case. Finally, FIG. 5 indicates the manner in which an auxiliary and base channel can be scheduled to work together to stream the video frames illustrated in FIG. 1 to achieve a nearly constant streaming rate.

Note that I2 is scheduled to be delivered a few frames before it is needed—this allows for rescheduling flexibility if the network stalls mid-way. Also note that P7, being larger in size than the average, is also partly pre-delivered via the auxiliary channel. As it is due before I2, its surplus is sent over the auxiliary channel before parts of I2 are sent over the same. Additional channel surplus available after the excess of I2 has been streamed can be used to pre-stream parts of subsequent large frames, as indicated. Finally, note that the I-frames in this example are never sent in the base channel. This is not necessary—parts of the I-frame can be carried in the base channel, according to their schedule. However, the above schedule reflects a more conservative approach. Should there have been B frames instead of the P-frames P10 and P11, then this schedule becomes imperative since I2 would then be required for the reconstruction of the 10th and 11th frames.

FIG. 6 provides an end-to-end flow diagram of an embodiment of the system described here, using push-streaming.

Any system embodied in this invention will typically consist of the following three processes:

Analysis of the data stream, client resources and connecting bandwidth to determine which data will be sent in the auxiliary stream and when. Care is to be taken not to exceed the memory capacity available at the client end, and not to compromise the rate of data flow of the normally streaming data parts. Analysis of the stream can be done (i) while compressing the media, (ii) off-line while the media is in storage, or (iii) online while streaming by the server. The second alternative is usually the best compromise in resources and efficiency—analysis while encoding is efficient but requires extra upload time to send the analysis results, while stream-time analysis places heavy demand on server capabilities.

Bookkeeping of data sent in the auxiliary stream, and its location with respect to the data in the main download stream. The design of such a component is not difficult to a person skilled in the art, and typically involves placing “bookmarks” in the base stream that relate to data previously sent via the auxiliary stream, that was correspondingly identified. Essentially, a foolproof packaging mechanism is required to clearly indicate the position, time and intra-bitstream dependencies of a given data packet. Control Data, that indicates bookmarks and associated information, can be carried implicitly within the streams or as part of a separate control stream.

Handling of parallel streams at the server and client ends, and reassembly of data by the client. Data on the server has to be properly marked for delivery via auxiliary or base data stream. At the player end, the decoder has to be fed with the correct data at the correct point of time.

Note that this scheme is not restricted to pushing only the immediately upcoming key frame in the auxiliary stream, nor is it restricted to pushing only key frame data. Areas of very high local bandwidth can be progressively pushed over the entire previous duration of the video, so long as the client has adequate storage, and the additional bookkeeping complexity can be accommodated in the system. Nor is the scheme restricted to having only one auxiliary stream—several streams may be instituted at differing priorities, possibly depending on the look-ahead distance they serve. For example, suppose we have a movie stream streaming at rate M where the local rate is 0.8*M at some time T1 for some duration (possibly a sequence of two people seated and talking), but is 1.5*M for some later time T2 for another duration (possibly a sequence of a car crash with explosions). One main and one auxiliary stream can exist, in an embodiment, throughout the duration of the movie stream. However, at T1, it is apparent that the full capacity M is not being used. In one embodiment, as described earlier, subsequent key frames can be streamed over the auxiliary channel to utilize this unsised bandwidth. However, in another embodiment, the scheduling algorithm may recognize that a high-rate segment is coming up at T2, and may open another auxiliary channel to use the 0.2M surplus to pre-stream sections of data from T2. Note that T2 is at a reasonably large lookahead when the channel is started up, and hence it may have the lowest priority in terms of bandwidth and scheduling under stalled conditions. However, as T2 comes closer, the first auxiliary channel could actually be given a lower priority than the second, going down to zero while the second auxiliary channel uses, say 0.4M. Once the 1.5M segment has passed and the stream returns to its nominal rate behaviour, the second auxiliary channel may be closed or reverted to low priority, with normal scheduling allocations once again taking force. Again, the bookkeeping, buffer management and data packaging sub-systems will be more complex, but they are certainly tractable. Also, when not one but several media streams are to be concurrently delivered, the available bandwidth can be distributed among these streams according to their requirements and priority, and each can be served by a base and one or more auxiliary streams. The algorithm to decide the specific priority and rate allocated to each download channel may be arbitrarily complex, but the basic principle of creating an auxiliary download mechanism when a base channel locally under-utilizes budgeted bandwidth remains the same. For example, suppose an application involves streaming a video of a newscast in parallel with stock ticker data. The bandwidth required by the video is likely to be several tens of times higher than that required by the stock ticker stream. However, both have key and dependent frames. Thus, Tortiose and Hare Streaming may be applied to both. Say the total bandwidth avilable is T. In an embodiment, 0.97*T of the bandwidth may be assigned to the video stream, and 0.03*T to the stock ticker stream. There are thus two base and two auxiliary streams in this embodiment. If a stall occurs, the stock ticker may be given higher priority, for instance. Say for some short time, the bandwidth drops to half the nominal rate, i.e. it is now H=0.5*T. Instead of adjusting the assigned bandwidths in the same ratio as under normal conditions, an embodiment could keep the stock ticker's bandwdith constant, i.e. make it 0.06*H (==0.03*T), and reduce that of the video to 0.94*H (==0.47T). Finally, note that the system and scheme is not limited to push-streaming. The main scheduling algorithm could, in an embodiment, be executed at the client end using the same statistics as input. Parts of the bitstream in such a case would be requested by the client and then be delivered by the server. All other parts of the system would continue to function as described above. Several types of optimizations are possible over the basic design described above, but a person skilled in the art will recognize that they are in keeping with the basic spirit and scheme of the invention. Finally, it must be emphasized that the scheme is by no means restricted to streaming video, even though the invention has been mostly explained via an embodiment that serves video streams. Any data stream that can be profiled and has locally large variations amidst generally limited-rate data can be more efficiently streamed using the system described here.

What is claimed is:

1. A novel dual-stream method of streaming variable-rate data.

2. The dual-stream method of claim 1, which is extendable to multiple streams.

3. A scheme to send parts of a stream with locally large bandwidth over one or more auxiliary channels while the rest of the data in that stream is sent over one or more base channels.

4. The scheme of claim 3, applicable to all types of multimedia where quality-sensitive material requires localized high bitrates as compared to the average bitrate requirement of the bitstream.

5. A method to maximize use of all available bandwidths to pre-stream such data in an auxiliary channel while streaming the rest of the presentation along a main channel.

6. The method of claim 5, as set forth in FIG. 6.
